(19) United States
(12) Patent Application Publication
(10) Pub. No.: US 2023/0396386 A1
(43) Pub. Date: Dec. 7, 2023

(54) DOWNLINK CONTROL INFORMATION INDICATING TRANSMISSION CONTROL INDICATOR STATES

(71) Applicant: LENOVO (BEIJING) LIMITED, Beijing (CN)

(72) Inventors: Chenxi Zhu, Fairfax, VA (US); Bingchao Liu, Beijing (CN); Yi Zhang, Beijing (CN)

(21) Appl. No.: 18/028,465

(22) PCT Filed: Sep. 25, 2020
(86) PCT No.: PCT/CN2020/117678

§ 371 Date: Mar. 24, 2023

(51) Int. Cl. H04L 5/00

(52) U.S. Cl. CPC H04L 5/0051; H04L 5/0092; H04L 5/0053

(57) ABSTRACT

Apparatuses, methods, and systems are disclosed for downlink control information indicating transmission control indicator states. One method (500) includes transmitting (502), to a UE, a DCI format indicating a PDSCH to the UE, wherein: the PDSCH comprises two TCI states corresponding to a plurality of DMRS antenna ports; a first TCI state of the two TCI states is associated with a first set of DMRS antenna ports of the plurality of DMRS antenna ports; a second TCI state of the two TCI states is associated with a second set of DMRS antenna ports of the plurality of DMRS antenna ports; and a first number of DMRS antenna ports of the first set of DMRS antenna ports is equal to a second number of DMRS antenna ports of the second set of DMRS antenna ports.

### FIELD

The subject matter disclosed herein relates generally to wireless communications and more particularly relates to downlink control information indicating transmission control indicator states.

### BACKGROUND

The following abbreviations are herewith defined, at least some of which are referred to within the following description: Third Generation Partnership Project (“3GPP”), 5G QoS Indicator (“5QI”), Acknowledge Mode (“AM”), Aperiodic (“AP”), Backhaul (“BH”), Broadcast Multicast (“BM”), Buffer Occupancy (“BO”), Base Station (“BS”), Buffer Status Report (“BSR”), Bandwidth (“BW”), Bandwidth Part (“BWP”), Carrier Aggregation (“CA”), Code Block Group (“CBG”), CBG Flushing Out Information (“CBGFI”), CBG Transmission Information (“CBGTI”), Component Carrier (“CC”), Code Division Multiplexing (“CDM”), Control Element (“CE”), Coordinated Multipoint (“CoMP”), Categories of Requirements (“CoR”), Control Resource Set (“CORESET”), Cyclic Prefix (“CP”), Cyclic Prefix OFDM (“CP-OFDM”), Cyclic Redundancy Check (“CRC”), CSI-RS Resource Indicator (“CRI”), Cell RNTI (“C-RNTI”), Channel State Information (“CSI”), CSI IM (“CSI-IM”), CSI RS (“CSI-RS”), Channel Quality Indicator (“CQI”), Central Unit (“CU”), Codeword (“CW”), Downlink Assignment Index (“DAI”), Downlink Control Information (“DCI”), Downlink Feedback Information (“DFI”), Downlink (“DL”), Discrete Fourier Transform Spread OFDM (“DFT-s-fOFDM”), Demodulation Reference Signal (“DMRS” or “DM-RS”), Data Radio Bearer (“DRB”), Dedicated Short-Range Communications (“DSRC”), Distributed Unit (“DU”), Enhanced Mobile Broadband (“eMBB”), Evolved Node B (“eNB”), Enhanced Subscriber Identification Module (“eSIM”), Enhanced (“E”), Frequency Division Duplex (“FDD”), Frequency Division Multiplexing (“BUM”), Frequency Division Multiple Access (“FDMA”), Frequency Range (“FR”), 450 MHz-6000 MHz (“FR1”), 24250 MHz-52600 MHz (“FR2”), Hybrid Automatic Repeat Request (“HARQ”), High-Definition Multimedia Interface (“HDMI”), High-Speed Train (“HST”), Integrated Access Backhaul (“IAB”), Identity or Identifier or Identification (“ID”), Information Element (“IE”), Interference Measurement (“IM”), International Mobile Subscriber Identity (“IMSI”), Internet-of-Things (“IoT”), Internet Protocol (“IP”), Joint Transmission (“JT”), Level 1 (“L1”), L1 RSRP (“L1-RSRP”), L1 SINR (“L1-SINR”), Logical Channel (“LCH”), Logical Channel Group (“LCG”), Logical Channel ID (“LCID”), Logical Channel Prioritization (“LCP”), Layer Indicator (“LI”), Least-Significant Bit (“LSB”), Long Term Evolution (“LTE”), Levels of Automation (“LoA”), Medium Access Control (“MAC”), Modulation Coding Scheme (“MCS”), Multi DCI (“M-DCI”), Master Information Block (“MIB”), Multiple Input Multiple Output (“MIMO”), Maximum Permissible Exposure (“MPE”), Most-Significant Bit (“MSB”), Mobile-Termination (“MT”), Machine Type Communication (“MTC”), Multi PDSCH (“Multi-PDSCH”), Multi TRP (“M-TRP”), Multi-User (“MU”), Multi-User MIMO (“MU-MIMO”), Minimum Mean Square Error (“MMSE”), Negative-Acknowledgment (“NACK”) or (“NAK”), Non-Coherent Joint Transmission (“NCJT”), Next Generation (“NG”), Next Generation Node B (“gNB”), New Radio (“NR”), Non-Zero Power (“NZP”), NZP CSI-RS (“NZP-CSI-RS”), Orthogonal Frequency Division Multiplexing (“OFDM”), Peak-to-Average Power Ratio (“PAPR”), Physical Broadcast Channel (“PBCH”), Physical Downlink Control Channel (“PDCCH”), Physical Downlink Shared Channel (“PDSCH”), PDSCH Configuration (“PDSCH-Config”), Policy Control Function (“PCF”), Packet Data Convergence Protocol (“PDCP”), Packet Data Network (“PDN”), Protocol Data Unit (“PDU”), Public Land Mobile Network (“PLMN”), Precoding Matrix Indicator (“PMI”), ProSe Per Packet Priority (“PPPP”), ProSe Per Packet Reliability (“PPPR”), Physical Resource Block (“PRB”), Packet Switched (“PS”), Physical Sidelink Control Channel (“PSCCH”), Physical Sidelink Shared Channel (“PSSCH”), Phase Tracking RS (“PTRS” or “PT-RS”), Physical Uplink Control Channel (“PUCCH”), Physical Uplink Shared Channel (“PUSCH”), Quasi Co-Located (“QCL”), Quality of Service (“QoS”), Random Access Channel (“RACH”), Radio Access Network (“RAN”), Radio Access Technology (“RAT”), Resource Element (“RE”), Radio Frequency (“RF”), Rank Indicator (“RI”), Radio Link Control (“RLC”), Radio Link Failure (“RLF”), Radio Network Temporary Identifier (“RNTI”), Resource Pool (“RP”), Radio Resource Control (“RRC”), Remote Radio Head (“RRH”), Reference Signal (“RS”), Reference Signal Received Power (“RSRP”), Reference Signal Received Quality (“RSRQ”), Redundancy Version (“RV”), Receive (“RX”), Single Carrier Frequency Domain Spread Spectrum (“SC-FDSS”), Secondary Cell (“SCell”), Spatial Channel Model (“SCM”), Sub Carrier Spacing (“SCS”), Single DCI (“S-DCI”), Spatial Division Multiplexing (“SDM”), Service Data Unit (“SDU”), Single Frequency Network (“SFN”), Subscriber Identity Module (“SIM”), Signal-to-Interference Ratio (“SINR”), Sidelink (“SL”), Sequence Number (“SN”), Semi Persistent (“SP”), Scheduling Request (“SR”), SRS Resource Indicator (“SRI”), Sounding Reference Signal (“SRS”), Synchronization Signal (“SS”), SS/PBCH Block (“SSB”), Transport Block (“TB”), Transmission Configuration Indication (“TCI”), Time Division Duplex (“TDD”), Time Division Multiplexing (“TDM”), Temporary Mobile Subscriber Identity (“TMSI”), Transmit Power Control (“TPC”), Transmitted Precoding Matrix Indicator (“TPMI”), Transmission Reception Point (“TRP”), Technical Standard (“TS”), Transmit (“TX”), User Entity/Equipment (Mobile Terminal) (“UE”), Universal Integrated Circuit Card (“UICC”), Uplink (“UL”), Unacknowledged Mode (“UM”), Universal Mobile Telecommunications System (“UMTS”), LTE Radio Interface (“Uu interface”), User Plane (“UP”), Ultra Reliable Low Latency Communication (“URLLC”), Universal Subscriber Identity Module (“USIM”), Universal Terrestrial Radio Access Network (“UTRAN”), Vehicle to Everything (“V2X”), Voice Over IP (“VoIP”), Visited Public Land Mobile Network (“VPLMN”), Virtual Resource Block (“VRB”), Vehicle RNTI (“V-RNTI”), Worldwide Interoperability for Microwave Access (“WiMAX”), Zero Forcing (“ZF”), Zero Power (“ZP”), and ZP CSI-RS (“ZP-CSI-RS”). As used herein, “HARQ-ACK” may represent collectively the Positive Acknowledge (“ACK”) and the Negative Acknowledge (“NAK”). ACK means that a TB is correctly received while NAK means a TB is erroneously received.

In certain wireless communications networks, DCI may be used to configure various items.

### BRIEF SUMMARY

Methods for downlink control information indicating transmission control indicator states are disclosed. Apparatuses and systems also perform the functions of the methods. In one embodiment, the method includes transmitting, to a user equipment, a downlink control information format indicating a physical downlink shared channel to the user equipment, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

An apparatus for downlink control information indicating transmission control indicator states, in one embodiment, includes a transmitter that transmits, to a user equipment, a downlink control information format indicating a physical downlink shared channel to the user equipment, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

A method for downlink control information indicating transmission control indicator states includes receiving, at a user equipment, a downlink control information format indicating a physical downlink shared channel, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

An apparatus for downlink control information indicating transmission control indicator states, in one embodiment, a user equipment, the apparatus further comprises: a receiver that receives a downlink control information format indicating a physical downlink shared channel, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for downlink control information indicating transmission control indicator states;

FIG. 2 is a schematic block diagram illustrating one embodiment of an apparatus that may be used for downlink control information indicating transmission control indicator states;

FIG. 3 is a schematic block diagram illustrating one embodiment of an apparatus that may be used for downlink control information indicating transmission control indicator states;

FIG. 4 is a schematic block diagram illustrating one embodiment of a system in which there is joint transmission from two TRPs to a UE;

FIG. 5 is a schematic flow chart diagram illustrating an embodiment of a method 500 for downlink control information indicating transmission control indicator states; and

FIG. 6 is a schematic flow chart diagram illustrating another embodiment of a method 600 for downlink control information indicating transmission control indicator states.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

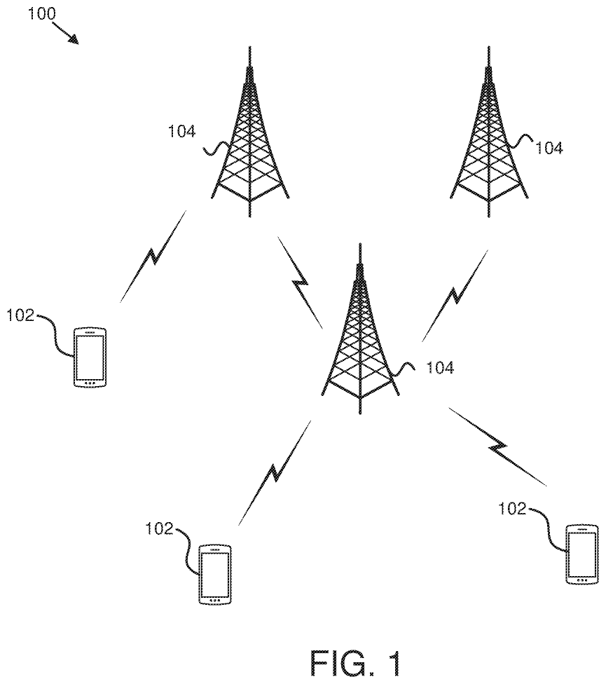

FIG. 1 depicts an embodiment of a wireless communication system 100 for downlink control information indicating transmission control indicator states. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a RAN, a relay node, a device, a network device, an IAB node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the 3GPP protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In some embodiments, a network unit 104 may transmit, to a user equipment (e.g., remote unit 102), a downlink control information format indicating a physical downlink shared channel to the user equipment, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports. Accordingly, a network unit 104 may be used for downlink control information indicating transmission control indicator states.

In various embodiments, a remote unit 102 (e.g., UE) may receive a downlink control information format indicating a physical downlink shared channel, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports. Accordingly, a remote unit 102 may be used for downlink control information indicating transmission control indicator states.

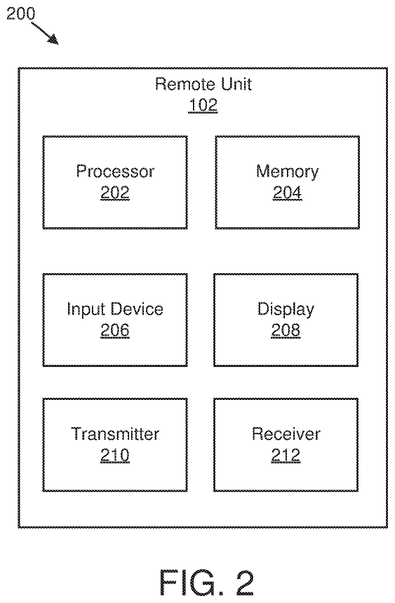

FIG. 2 depicts one embodiment of an apparatus 200 that may be used for downlink control information indicating transmission control indicator states. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, an LCD display, an LED display, an OLED display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the transmitter 210 may be used for transmitting information described herein and/or the receiver 212 may be used for receiving information described herein and/or the processor 202 may be used for processing information described herein.

In some embodiments, the receiver 212 may receive a downlink control information format indicating a physical downlink shared channel, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

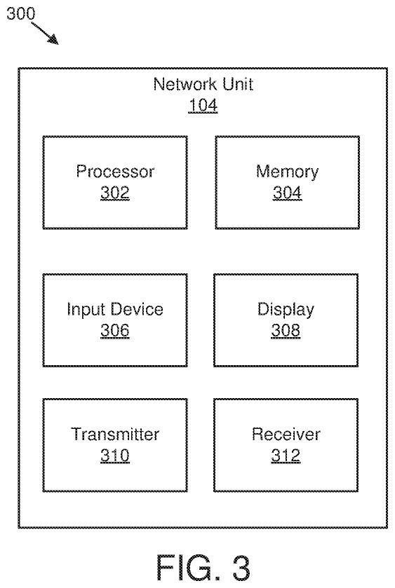

FIG. 3 depicts one embodiment of an apparatus 300 that may be used for downlink control information indicating transmission control indicator states. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In various embodiments, the transmitter 310 may transmit, to a user equipment, a downlink control information format indicating a physical downlink shared channel to the user equipment, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

In certain embodiments, a PDSCH transmission scheme may be used to enhance reliability by employing two sets of DM-RS associated with different TCI states and transmitted in separate CDM groups, while transmitting data jointly. Such embodiments may facilitate better channel estimation for multi-TRP scenario if the channels from two TRPs exhibit different (e.g., substantially different) Doppler shifts. Moreover, in such embodiments, an overhead for DM-RS may be high by using two different CDM groups. In some embodiments, two sets of DM-RS ports may share the same CDM group. In such embodiments, an overhead for DM-RS ports that are part of one CDM group may be less than an overhead for DM-RS ports that are part of more than one CMD group.

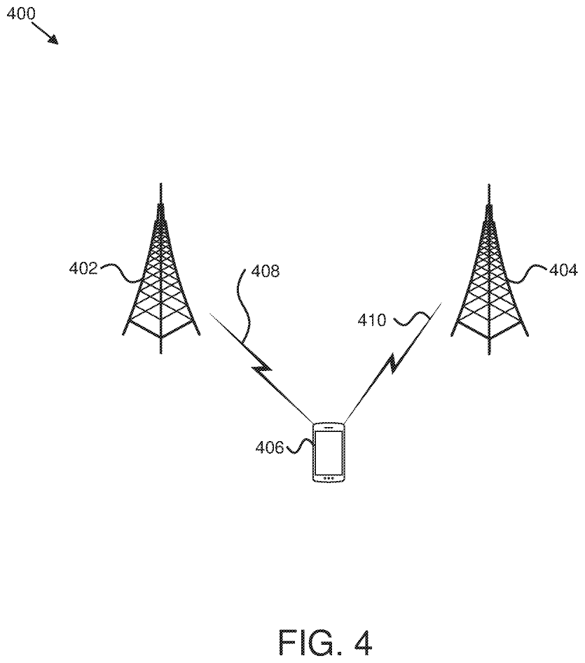

FIG. 4 is a schematic block diagram illustrating one embodiment of a system 400 in which there is joint transmission from two TRPs to a UE. The system 400 includes a first TRP 402, a second TRP 404, and a UE 406. The first TRP 402 communicates with the UE 406 via first messages 408 (e.g., CSI-RS1, DMRS group1, CW1, RV0, PTRS1) and the second TRP 404 communicates with the UE 406 via second messages 410 (e.g., CSI-RS2, DMRS group2, CW1, RV0, PTRS2).

In various embodiments, in a PDSCH joint transmission scheme, two TRPs (e.g., the first TRP 402, the second TRP 404) of a same cell may transmit their CSI-RS in separate CSI-RS resources. In such embodiments, separate CSI-RS resources are configured and transmitted for different TRPs. By separating CSI-RS signals from different TRPs in a time and/or frequency domain, the UE 406 may easily distinguish different DL signals from different TRPs with different pathloss and different Doppler shifts and estimate each channel respectively. Pairs of NZP-CSI-RS resources may be configured for channel measurement and interference measurement. For the transmission of PDSCH with a multi-TRP system, two TCI states may be indicated by a TCI indicator (e.g., TCI field) in a DCI format (e.g., DCI format 1_1, DCI format 1_2). Each TCI state may be associated with DM-RS sent from a TRP and the DMRS ports of PDSCH. In some embodiments, the same number (e.g., K) of DM-RS ports may be transmitted by the two TRPs. In one example, assume the DM-RS ports transmitted by the first TRP are {P₁^{TCI1}, . . . , P_{K}^{TCI1}}, and the DM-RS ports transmitted by the second TRP are {P₁^{TCI2}, . . . , P_{K}^{TCI2}}. In certain single-DCI multi-TRP PDSCH transmission embodiments, all K ports transmitted by the same TRP are in one DMRS CDM group and a total of 2*K ports are in 2 CDM groups.

In some embodiments, DMRS ports transmitted by a TRP do not occupy a DMRS CDM group exclusively. For example, in certain embodiments, if indicated DMRS ports are from the same DMRS CDM group, the first K ports of the DMRS are associated with a first TCI state, and the rest of the K ports of DMRS are associated with a second TCI state indicated by a TCI indicator (e.g., TCI field) in DCI. As another example, in various embodiments, if indicated DMRS ports are from 2 different CDM groups, the DMRS ports in a first CDM group are associated with a first TCI state, and the DMRS ports in a second CDM group are associated with a second TCI state. As may be appreciated, enabling DMRS ports to be transmitted in a single CDM group from two TRPs may have the benefit of reducing a number of CDM groups used for a UE. This may either increase a number of REs used for data and/or increase a MU-MIMO capacity by a number of UEs simultaneously scheduled. This can be seen from DMRS port indications in Table 1.

TABLE 1
Antenna port(s) (1000 + DMRS port), dmrs-Type = 1, maxLength = 1
One Codeword:
Codeword 0 enabled,
Codeword 1 disabled

| | Number of DMRS | |
|---|---|---|
| | CDM group(s) | DMRS |
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12 | 2 | 0, 2, 3 |
| 13-15 | Reserved | Reserved |

The DMRS entries for values 2, 7, 8, 10, and 11 in Table 1 may be used for the above described transmission scheme. For example, the row corresponding to the value of 2 indicates 2 DMRS ports to be transmitted in 1 CDM group, thereby enabling 1 data layer of SFN transmission. The rows corresponding to the values of 7 and 8 each indicate two DMRS ports in separate CDM groups, thereby enabling MU-MIMO of 2 UEs each with 1 layer of data transmission. The row corresponding to the value of 11 indicates 2 DMRS ports in 2 CDM groups. The row corresponding to the value of 10 indicates 4 DMRS ports in which ports 0 and 1 are associated with a first TCI state are in a first CDM group, and ports 2 and 3 are associated with a second TCI state and are in a second CDM group. As compared with other embodiments, embodiments described herein may enable more scheduling flexibility. In various embodiments, a gNB may schedule 1 UE with 2 ports in 1 CDM group (e.g., row corresponding to the value of 2) to save DMRS RE overhead, may schedule 1 UE with 2 ports in 2 CDM group (e.g., row corresponding to the value of 11) to enable FDM between the 2 DMRS ports for easy channel estimation, and/or may schedule 2 UEs each with 2 ports in a CDM group (e.g., schedule a first UE with the row corresponding to the value of 7 with 2 ports in a first CDM group, and schedule a second UE with the row corresponding to the value of 8 with 2 ports in a second CDM group) for MU-MIMO transmission.

Table 2 illustrates a simplified table that may be used in place of Table 1. By using the simplified table that only includes certain entries, transmission bandwidth and/or storage space may be reduced as compared to using Table 1.

TABLE 2
Antenna port(s) (1000 + DMRS port), dmrs-Type = 1, maxLength = 1
One Codeword:
Codeword 0 enabled,
Codeword 1 disabled

| | Number of DMRS | |
|---|---|---|
| | CDM group(s) | DMRS |
| Value | without data | port(s) |
| 2 | 1 | 0, 1 |
| 7 | 2 | 0, 1 |
| 8 | 2 | 2, 3 |
| 10 | 2 | 0-3 |
| 11 | 2 | 0, 2 |

Similarly to Tables 1 and 2, the DMRS port entries of Table 3 may be used to schedule SFN transmission (e.g., entries in the One Codeword section with values of 2, 7, 8, 10, 11, 20, 21, 22, 23, 28, 29, and 30, entries in the Two Codeword section with values of 1 and 3). In certain embodiments, a gNB may schedule a UE with great flexibility by using Table 3. For example, in one embodiment, a single UE may be scheduled with DMRS based on the row corresponding to the value 2 with ports 0 and 1 in 1 CDM group—One Codeword section, thereby reducing DMRS RE overhead, and pairs of UEs can be scheduled with DMRS based on the row corresponding to the values 7 and 8 (or 20 and 21) simultaneously (from the One Codeword section), each with 2 DMRS ports in a CDM group. In another example, in one embodiment for higher order transmission of rank 3 or rank 4, a single UE may be scheduled the row corresponding to the values 1 or 3 (from the Two Codeword section). By using Table 3, a gNB may have flexibility similar to the embodiments that use Table 1. As may be appreciated, similar benefits to the benefits described in relation to Tables 1 and 3 may be achieved if a gNB schedules a UE using dmrs-Type2.

TABLE 3
Antenna port(s) (1000 + DMRS port), dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number of | | DMRS CDM | | Number of |
| | group(s) | DMRS | front-load | | group(s) | | front-load |
| Value | without data | port(s) | symbols | Value | without data | DMRS port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |

Table 4 illustrates a simplified table that may be used in place of Table 3. By using the simplified table that only includes certain entries, transmission bandwidth and/or storage space may be reduced as compared to using Table 3.

TABLE 4
Antenna port(s) (1000 + DMRS port), dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | | | Number of | | |
| | DMRS CDM | | Number of | | DMRS CDM | | Number of |
| | group(s) | DMRS | front-load | | group(s) | | front-load |
| Value | without data | port(s) | symbols | Value | without data | DMRS port(s) | symbols |
| 2 | 1 | 0, 1 | 1 | 1 | 2 | 0, 1, 2, 3, 4, 6 | 2 |
| 7 | 2 | 0, 1 | 1 | 3 | 2 | 0, 1, 2, 3, 4, 5, 6, 7 | 2 |
| 8 | 2 | 2, 3 | 1 | | | | |
| 10 | 2 | 0-3 | 1 | | | | |
| 11 | 2 | 0, 2 | 1 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |

In some embodiments, such as for data transmission in a PDSCH, K layers of data may be transmitted and each data layer may be associated with a pair of DMRS ports. In various embodiments, if all 2K DMRS ports indicated by DCI are in a single DMRS CDM group, the first K DMRS ports are associated with a first TCI state, and the remaining K DMRS ports are associated with a second TCI state indicated by a TCI indicator (e.g., TCI field) of the DCI. In certain embodiments, if all 2K DMRS ports indicated by DCI are in two DMRS CDM groups, the K DMRS ports in a first CDM group indicated by a first DMRS port are associated with a first TCI state, and the remaining K DMRS ports in a second CDM group are associated with a second TCI state indicated by a TCI indicator (e.g., TCI field) of the DCI. In some embodiments, for either one or two CDM group embodiments, the first K ports may be associated with a first TCI and may be {P₁^{TCI1}, . . . , P_{K}^{TCI1}}, and the remaining K ports may be associated with a second TCI and may be {P₁^{TCI2}, . . . , P_{K}^{TCI2}}. In such embodiments, an ith data layer may be associated with a pair of DMRS ports {Pᵢ^{TCI1}, . . . , Pᵢ^{TCI2}}. As may be appreciated, considering a transmission reliability requirement, it may be reasonable to limit K≤4 and only a single codeword may be transmitted in PDSCH.

In a first example, the UE 406 of FIG. 4 is configured with DMRS based on Table 1 (dmrs-Type=1, maxLength=1). In this example, if a DCI format (e.g., DCI format 1-1) indicates to the UE 406 a TCI codepoint with 2 TCI states (e.g., TCI1=CSI-RS1, TCI2=CSI-RS2), and DMRS indicates a value 2 (e.g., ports 0 and 1), the UE 406 associates DMRS port 0 with TCI1, and DMRS port 1 with TCI2. Thus, PDSCH is transmitted with a single data layer associated with both DMRS port 0 and 1. In this example, if DMRS indicates a value of 10 (ports 0-3), the DMRS ports 0 and 1 are in a first CDM group (containing DMRS port 0) associated with TCI1, and DMRS ports 2 and 3 are in a second CDM group associated with TCI2. Thus, PDSCH data is transmitted in 2 layers, where a first data layer is associated with DMRS ports 0 and 2, and a second data layer is associated with DMRS ports 1 and 3.

In a second example, two UEs (e.g., UE1 and UE2) are both configured with DMRS based on Table 3 (dmrs-Type=1, maxLength=2). In this example, UE1 is scheduled with TCI states (TCI1=CSI-RS1, TCI2=CSI-RS2) and a DMRS value=7 (port 0 and 1), and UE2 is scheduled with TCI states (TCI3=CSI-RS1, TCI4=CSI-RS2) and a DMRS value=8 (port 2 and 3). Thus, UE1 associates DMRS port 0 with TCI1, and DMRS port 1 with TCI2. A single data layer associated with DMRS port 0 and 1 is transmitted to UE1 in PDSCH1. UE2 associates DMRS port 2 with TCI3, and DMRS port 3 with TCI4. A single data layer associated with DMRS port 0 and 1 is transmitted to UE2 in PDSCH2. MU-MIMO transmission to UE1 and UE2 may be achieved with a total of 2 data layers to 2 UEs.

In some embodiments, if indicated DMRS ports are from one DMRS CDM group, a first half of the DMRS ports may be associated with a first TCI state, and a second half of the DMRS ports may be associated with a second TCI state. In certain embodiments, if indicated DMRS ports are from two DMRS CDM groups, the DMRS ports in a first CDM group are associated with a first TCI state, and the second DMRS ports in a second CDM group are associated with a second TCI state. In various embodiments, DMRS ports are divided into two groups of equal size with different TCIs. For example, let the DM-RS ports with a first TCI be {P₁^{TCI1}, . . . , P_{K}^{TCI1}}, and the DM-RS ports with a second TCI be {P₁^{TCI2}, . . . , P_{K}^{TCI2}}. A pair of DMRS ports with different TCIs, i.e. {Pₖ^{TCI1}, . . . , Pₖ^{TCI2}}, may used for transmission of a kth data layer of the PDSCH.

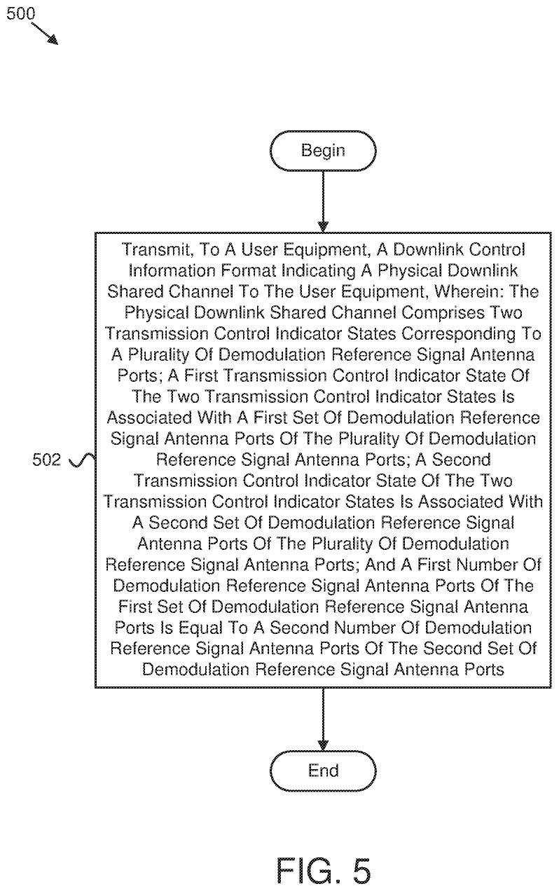

FIG. 5 is a schematic flow chart diagram illustrating an embodiment of a method 500 for downlink control information indicating transmission control indicator states. In some embodiments, the method 500 is performed by an apparatus, such as the network unit 104. In certain embodiments, the method 500 may be performed by a processor executing program code, for example, a microcontroller, a microprocessor, a CPU, a GPU, an auxiliary processing unit, a FPGA, or the like.

The method 500 may include transmitting 502, to a user equipment (e.g., remote unit 102), a downlink control information format indicating a physical downlink shared channel to the user equipment, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

In certain embodiments: the plurality of demodulation reference signal antenna ports is in a single demodulation reference signal code-division multiplexing group; the first set of demodulation reference signal antenna ports correspond to a first half of the plurality of demodulation reference signal antenna ports; and the second set of demodulation reference signal antenna ports correspond to a second half of the plurality of demodulation reference signal antenna ports. In some embodiments: the plurality of demodulation reference signal antenna ports is in two demodulation reference signal code-division multiplexing groups; the first set of demodulation reference signal antenna ports correspond to a first demodulation reference signal code-division multiplexing group of the two demodulation reference signal code-division multiplexing groups; and the second set of demodulation reference signal antenna ports correspond to a second demodulation reference signal code-division multiplexing group of the two demodulation reference signal code-division multiplexing groups.

In various embodiments, each data layer of the physical downlink shared channel is configured to be transmitted using a pair of demodulation reference signal ports of the plurality of demodulation reference signal antenna ports with different transmission control indicator states. In one embodiment, a first demodulation reference signal port of the first set of demodulation reference signal antenna ports is paired with a corresponding second demodulation reference signal port of the second set of demodulation reference signal antenna ports for transmission of a corresponding data layer of the physical downlink shared channel. In certain embodiments, the first transmission control indicator state represents a type A quasi-colocation and a type D quasi-colocation for frequency range 2 for a first transmission reception point, and the second transmission control indicator state represents a type A quasi-colocation and a type D quasi-colocation for frequency range 2 for a second transmission reception point.

In some embodiments, the method 500 further comprises transmitting the physical downlink shared channel to the user equipment with the two transmission control indicator states and the plurality of demodulation reference signal antenna ports based on the downlink control information format. In various embodiments, the downlink control information format comprises a downlink control information format 1_1 or a downlink control information format 1_2.

In one embodiment, the method 500 further comprises receiving a capability report of the user equipment, wherein the capability report comprises information indicating an ability of the user equipment to receive the downlink control information format. In certain embodiments, the method 500 further comprises transmitting an indication of demodulation reference signal ports used based on a first demodulation reference signal indication table having a first size, wherein the first size is smaller than a second size of a second demodulation reference signal indication table.

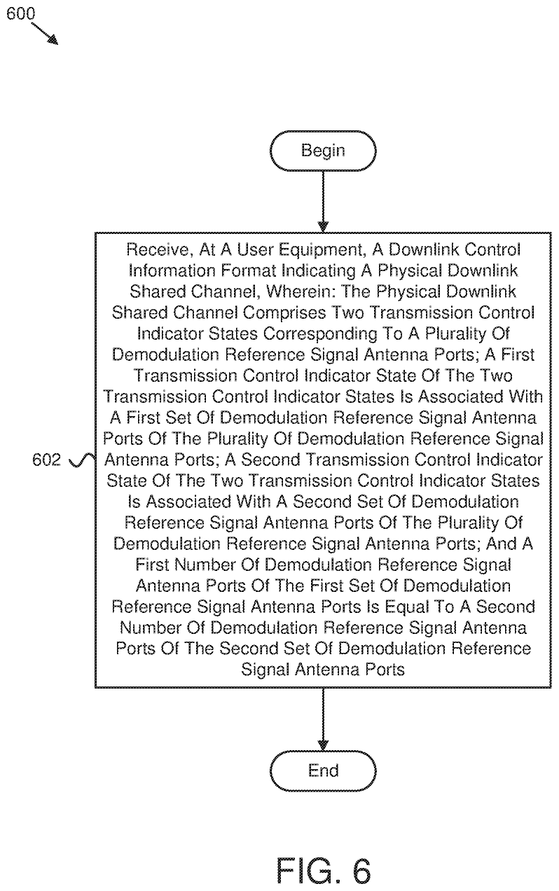

FIG. 6 is a schematic flow chart diagram illustrating another embodiment of a method 600 for downlink control information indicating transmission control indicator states. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

The method 600 may include receiving 602, at a user equipment (e.g., remote unit 102), a downlink control information format indicating a physical downlink shared channel, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

In certain embodiments: the plurality of demodulation reference signal antenna ports is in a single demodulation reference signal code-division multiplexing group; the first set of demodulation reference signal antenna ports correspond to a first half of the plurality of demodulation reference signal antenna ports; and the second set of demodulation reference signal antenna ports correspond to a second half of the plurality of demodulation reference signal antenna ports. In some embodiments: the plurality of demodulation reference signal antenna ports is in two demodulation reference signal code-division multiplexing groups; the first set of demodulation reference signal antenna ports correspond to a first demodulation reference signal code-division multiplexing group of the two demodulation reference signal code-division multiplexing groups; and the second set of demodulation reference signal antenna ports correspond to a second demodulation reference signal code-division multiplexing group of the two demodulation reference signal code-division multiplexing groups.

In various embodiments, each data layer of the physical downlink shared channel is configured to be received using a pair of demodulation reference signal ports of the plurality of demodulation reference signal antenna ports with different transmission control indicator states. In one embodiment, a first demodulation reference signal port of the first set of demodulation reference signal antenna ports is paired with a corresponding second demodulation reference signal port of the second set of demodulation reference signal antenna ports for receiving a corresponding data layer of the physical downlink shared channel. In certain embodiments, the first transmission control indicator state represents a type A quasi-colocation and a type D quasi-colocation for frequency range 2 for a first transmission reception point, and the second transmission control indicator state represents a type A quasi-colocation and a type D quasi-colocation for frequency range 2 for a second transmission reception point.

In some embodiments, the method 600 further comprises receiving the physical downlink shared channel with the two transmission control indicator states and the plurality of demodulation reference signal antenna ports based on the downlink control information format. In various embodiments, the downlink control information format comprises a downlink control information format 1_1 or a downlink control information format 1_2. In one embodiment, the method 600 further comprises transmitting a capability report of the user equipment, wherein the capability report comprises information indicating an ability of the user equipment to receive the downlink control information format. In certain embodiments, the method 600 further comprises receiving an indication of demodulation reference signal ports used based on a first demodulation reference signal indication table having a first size, wherein the first size is smaller than a second size of a second demodulation reference signal indication table.

In one embodiment, a method comprises: transmitting, to a user equipment, a downlink control information format indicating a physical downlink shared channel to the user equipment, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

In certain embodiments: the plurality of demodulation reference signal antenna ports is in a single demodulation reference signal code-division multiplexing group; the first set of demodulation reference signal antenna ports correspond to a first half of the plurality of demodulation reference signal antenna ports; and the second set of demodulation reference signal antenna ports correspond to a second half of the plurality of demodulation reference signal antenna ports.

In some embodiments: the plurality of demodulation reference signal antenna ports is in two demodulation reference signal code-division multiplexing groups; the first set of demodulation reference signal antenna ports correspond to a first demodulation reference signal code-division multiplexing group of the two demodulation reference signal code-division multiplexing groups; and the second set of demodulation reference signal antenna ports correspond to a second demodulation reference signal code-division multiplexing group of the two demodulation reference signal code-division multiplexing groups.

In various embodiments, each data layer of the physical downlink shared channel is configured to be transmitted using a pair of demodulation reference signal ports of the plurality of demodulation reference signal antenna ports with different transmission control indicator states.

In one embodiment, a first demodulation reference signal port of the first set of demodulation reference signal antenna ports is paired with a corresponding second demodulation reference signal port of the second set of demodulation reference signal antenna ports for transmission of a corresponding data layer of the physical downlink shared channel.

In certain embodiments, the first transmission control indicator state represents a type A quasi-colocation and a type D quasi-colocation for frequency range 2 for a first transmission reception point, and the second transmission control indicator state represents a type A quasi-colocation and a type D quasi-colocation for frequency range 2 for a second transmission reception point.

In some embodiments, the method further comprises transmitting the physical downlink shared channel to the user equipment with the two transmission control indicator states and the plurality of demodulation reference signal antenna ports based on the downlink control information format.

In various embodiments, the downlink control information format comprises a downlink control information format 1_1 or a downlink control information format 1_2.

In one embodiment, the method further comprises receiving a capability report of the user equipment, wherein the capability report comprises information indicating an ability of the user equipment to receive the downlink control information format.

In certain embodiments, the method further comprises transmitting an indication of demodulation reference signal ports used based on a first demodulation reference signal indication table having a first size, wherein the first size is smaller than a second size of a second demodulation reference signal indication table.

In one embodiment, an apparatus comprises: a transmitter that transmits, to a user equipment, a downlink control information format indicating a physical downlink shared channel to the user equipment, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

In certain embodiments: the plurality of demodulation reference signal antenna ports is in a single demodulation reference signal code-division multiplexing group; the first set of demodulation reference signal antenna ports correspond to a first half of the plurality of demodulation reference signal antenna ports; and the second set of demodulation reference signal antenna ports correspond to a second half of the plurality of demodulation reference signal antenna ports.

In some embodiments: the plurality of demodulation reference signal antenna ports is in two demodulation reference signal code-division multiplexing groups; the first set of demodulation reference signal antenna ports correspond to a first demodulation reference signal code-division multiplexing group of the two demodulation reference signal code-division multiplexing groups; and the second set of demodulation reference signal antenna ports correspond to a second demodulation reference signal code-division multiplexing group of the two demodulation reference signal code-division multiplexing groups.

In various embodiments, each data layer of the physical downlink shared channel is configured to be transmitted using a pair of demodulation reference signal ports of the plurality of demodulation reference signal antenna ports with different transmission control indicator states.

In one embodiment, a first demodulation reference signal port of the first set of demodulation reference signal antenna ports is paired with a corresponding second demodulation reference signal port of the second set of demodulation reference signal antenna ports for transmission of a corresponding data layer of the physical downlink shared channel.

In certain embodiments, the first transmission control indicator state represents a type A quasi-colocation and a type D quasi-colocation for frequency range 2 for a first transmission reception point, and the second transmission control indicator state represents a type A quasi-colocation and a type D quasi-colocation for frequency range 2 for a second transmission reception point.

In some embodiments, the transmitter transmits the physical downlink shared channel to the user equipment with the two transmission control indicator states and the plurality of demodulation reference signal antenna ports based on the downlink control information format.

In various embodiments, the downlink control information format comprises a downlink control information format 1_1 or a downlink control information format 1_2.

In one embodiment, the apparatus further comprises a receiver that receives a capability report of the user equipment, wherein the capability report comprises information indicating an ability of the user equipment to receive the downlink control information format.

In certain embodiments, the transmitter transmits an indication of demodulation reference signal ports used based on a first demodulation reference signal indication table having a first size, wherein the first size is smaller than a second size of a second demodulation reference signal indication table.

In one embodiment, a method comprises: receiving, at a user equipment, a downlink control information format indicating a physical downlink shared channel, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

In certain embodiments: the plurality of demodulation reference signal antenna ports is in a single demodulation reference signal code-division multiplexing group; the first set of demodulation reference signal antenna ports correspond to a first half of the plurality of demodulation reference signal antenna ports; and the second set of demodulation reference signal antenna ports correspond to a second half of the plurality of demodulation reference signal antenna ports.

In some embodiments: the plurality of demodulation reference signal antenna ports is in two demodulation reference signal code-division multiplexing groups; the first set of demodulation reference signal antenna ports correspond to a first demodulation reference signal code-division multiplexing group of the two demodulation reference signal code-division multiplexing groups; and the second set of demodulation reference signal antenna ports correspond to a second demodulation reference signal code-division multiplexing group of the two demodulation reference signal code-division multiplexing groups.

In various embodiments, each data layer of the physical downlink shared channel is configured to be received using a pair of demodulation reference signal ports of the plurality of demodulation reference signal antenna ports with different transmission control indicator states.

In one embodiment, a first demodulation reference signal port of the first set of demodulation reference signal antenna ports is paired with a corresponding second demodulation reference signal port of the second set of demodulation reference signal antenna ports for receiving a corresponding data layer of the physical downlink shared channel.

In certain embodiments, the first transmission control indicator state represents a type A quasi-colocation and a type D quasi-colocation for frequency range 2 for a first transmission reception point, and the second transmission control indicator state represents a type A quasi-colocation and a type D quasi-colocation for frequency range 2 for a second transmission reception point.

In some embodiments, the method further comprises receiving the physical downlink shared channel with the two transmission control indicator states and the plurality of demodulation reference signal antenna ports based on the downlink control information format.

In various embodiments, the downlink control information format comprises a downlink control information format 1_1 or a downlink control information format 1_2.

In one embodiment, the method further comprises transmitting a capability report of the user equipment, wherein the capability report comprises information indicating an ability of the user equipment to receive the downlink control information format.

In certain embodiments, the method further comprises receiving an indication of demodulation reference signal ports used based on a first demodulation reference signal indication table having a first size, wherein the first size is smaller than a second size of a second demodulation reference signal indication table.

In one embodiment, an apparatus comprises a user equipment, the apparatus further comprises: a receiver that receives a downlink control information format indicating a physical downlink shared channel, wherein: the physical downlink shared channel comprises two transmission control indicator states corresponding to a plurality of demodulation reference signal antenna ports; a first transmission control indicator state of the two transmission control indicator states is associated with a first set of demodulation reference signal antenna ports of the plurality of demodulation reference signal antenna ports; a second transmission control indicator state of the two transmission control indicator states is associated with a second set of demodulation reference signal antenna ports of the plurality of demodulation reference signal antenna ports; and a first number of demodulation reference signal antenna ports of the first set of demodulation reference signal antenna ports is equal to a second number of demodulation reference signal antenna ports of the second set of demodulation reference signal antenna ports.

In certain embodiments: the plurality of demodulation reference signal antenna ports is in a single demodulation reference signal code-division multiplexing group; the first set of demodulation reference signal antenna ports correspond to a first half of the plurality of demodulation reference signal antenna ports; and the second set of demodulation reference signal antenna ports correspond to a second half of the plurality of demodulation reference signal antenna ports.

In some embodiments: the plurality of demodulation reference signal antenna ports is in two demodulation reference signal code-division multiplexing groups; the first set of demodulation reference signal antenna ports correspond to a first demodulation reference signal code-division multiplexing group of the two demodulation reference signal code-division multiplexing groups; and the second set of demodulation reference signal antenna ports correspond to a second demodulation reference signal code-division multiplexing group of the two demodulation reference signal code-division multiplexing groups.

In various embodiments, each data layer of the physical downlink shared channel is configured to be received using a pair of demodulation reference signal ports of the plurality of demodulation reference signal antenna ports with different transmission control indicator states.

In one embodiment, a first demodulation reference signal port of the first set of demodulation reference signal antenna ports is paired with a corresponding second demodulation reference signal port of the second set of demodulation reference signal antenna ports for receiving a corresponding data layer of the physical downlink shared channel.

In certain embodiments, the first transmission control indicator state represents a type A quasi-colocation and a type D quasi-colocation for frequency range 2 for a first transmission reception point, and the second transmission control indicator state represents a type A quasi-colocation and a type D quasi-colocation for frequency range 2 for a second transmission reception point.

In some embodiments, the receiver receives the physical downlink shared channel with the two transmission control indicator states and the plurality of demodulation reference signal antenna ports based on the downlink control information format.

In various embodiments, the downlink control information format comprises a downlink control information format 1_1 or a downlink control information format 1_2.

In one embodiment, the apparatus further comprises a transmitter that transmits a capability report of the user equipment, wherein the capability report comprises information indicating an ability of the user equipment to receive the downlink control information format.

In certain embodiments, the receiver receives an indication of demodulation reference signal ports used based on a first demodulation reference signal indication table having a first size, wherein the first size is smaller than a second size of a second demodulation reference signal indication table.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Please make the following amendments to the claims:

1. A method for wireless communication, the method comprising:
transmitting, to a user equipment (UE), a downlink control information (DCI) format indicating a physical downlink shared channel (PDSCH) to the UE, wherein:
the PDSCH comprises two transmission control indicator (TCI) states corresponding to a plurality of demodulation reference signal (DMRS) antenna ports;
a TCI state of the two TCI states is associated with a first set of DMRS antenna ports of the plurality of DMRS antenna ports;
a second TCI state of the two TCI states is associated with a second set of DMRS antenna ports of the plurality of DMRS antenna ports; and
a first number of DMRS antenna ports of the first set of DMRS antenna ports is equal to a second number of DMRS antenna ports of the second set of DMRS antenna ports.

2. The method of claim 1, wherein:
the plurality of DMRS antenna ports is in a single DMRS code-division multiplexing (CDM) group;
the first set of DMRS antenna ports correspond to a first half of the plurality of DMRS antenna ports; and
the second set of DMRS antenna ports correspond to a second half of the plurality of DMRS antenna ports.

3. The method of claim 1, wherein:
the plurality of DMRS antenna ports is in two DMRS code-division multiplexing (CDM) groups;
the first set of DMRS antenna ports correspond to a first DMRS reference signal CDM group of the two DMRS reference signal CDM groups; and
the second set of DMRS antenna ports correspond to a second DMRS reference signal CDM group of the two DMRS CDM groups.

4. The method of claim 1, wherein each data layer of the PDSCH is configured to be transmitted using a pair of DMRS ports of the plurality of DMRS antenna ports with different TCI states.

5. The method of claim 4, wherein a first DMRS port of the first set of DMRS antenna ports is paired with a corresponding second DMRS port of the second set of DMRS antenna ports for transmission of a corresponding data layer of the PDSCH.

6. A method for wireless communication, the method comprising:
receiving, at a user equipment (UE), a downlink control information (DCI) format indicating a physical downlink shared channel (PDSCH), wherein:
the PDSCH comprises two transmission control indicator (TCI) states corresponding to a plurality of demodulation reference signal (DMRS) antenna ports;
a first TCI state of the two TCI states is associated with a first set of DMRS antenna ports of the plurality of DMRS antenna ports;
a second TCI state of the two TCI states is associated with a second set of DMRS antenna ports of the plurality of DMRS antenna ports; and
a first number of DMRS antenna ports of the first set of DMRS antenna ports is equal to a second number of DMRS antenna ports of the second set of DMRS antenna ports.

7. The method of claim 6, wherein:
the plurality of DMRS antenna ports is in a single DMRS code-division multiplexing (CDM) group;
the first set of DMRS antenna ports correspond to a first half of the plurality of DMRS antenna ports; and
the second set of DMRS antenna ports correspond to a second half of the plurality of DMRS antenna ports.

8. The method of claim 6, wherein:
the plurality of DMRS antenna ports is in two DMRS code-division multiplexing (CDM) groups;
the first set of DMRS antenna ports correspond to a first DMRS CDM group of the two DMRS CDM groups; and
the second set of DMRS antenna ports correspond to a second DMRS CDM group of the two DMRS CDM multiplexing groups.

9. The method of claim 6, wherein each data layer of the PDSCH is configured to be received using a pair of DMRS ports of the plurality of DMRS antenna ports with different TCI states.

10. The method of claim 9, wherein a first DMRS port of the first set of DMRS antenna ports is paired with a corresponding second DMRS port of the second set of DMRS antenna ports for receiving a corresponding data layer of the PDSCH.

11. The method of claim 6, wherein the first TCI state represents a type A quasi-colocation (QCL) and a type D QCL for frequency range 2 for a first transmission reception point, and the second TCI state represents a type A QCL and a type D QCL for frequency range 2 for a second transmission reception point.

12. The method of claim 6, further comprising receiving the PDSCH with the two TCI states and the plurality of DMRS antenna ports based on the DCI format.

13. The method of claim 6, wherein the DCI format comprises a DCI format 1_1 or a DCI format 1_2.

14. The method of claim 6, further comprising transmitting a capability report of the UE, wherein the capability report comprises information indicating an ability of the UE to receive the DCI format.

15. The method of claim 6, further comprising receiving an indication of DMRS ports used based on a first DMRS indication table having a first size, wherein the first size is smaller than a second size of a second DMRS indication table.

16. An apparatus for wireless communication, the apparatus comprising:
a processor; and
a memory coupled to the processor, the memory comprising instructions executable by the processor to cause the apparatus to:
transmit, to a user equipment (UE), a downlink control information (DCI) format indicating a physical downlink shared channel (PDSCH) to the UE, wherein:
the PDSCH comprises two transmission control indicator (TCI) states corresponding to a plurality of demodulation reference signal (DMRS) antenna ports;
a first TCI state of the two TCI states is associated with a first set of DMRS antenna ports of the plurality of DMRS antenna ports;
a second TCI state of the two TCI states is associated with a second set of DMRS antenna ports of the plurality of DMRS antenna ports; and
a first number of DMRS antenna ports of the first set of DMRS antenna ports is equal to a second number of DMRS antenna ports of the second set of DMRS antenna ports.

17. The apparatus of claim 16, wherein:
the plurality of DMRS antenna ports is in a single DMRS code-division multiplexing (CDM) group;
the first set of DMRS antenna ports correspond to a first half of the plurality of DMRS antenna ports; and
the second set of DMRS antenna ports correspond to a second half of the plurality of DMRS antenna ports.

18. The apparatus of claim 16, wherein:
the plurality of DMRS antenna ports is in two DMRS code-division multiplexing (CDM) groups;
the first set of DMRS antenna ports correspond to a first DMRS CDM group of the two DMRS CDM groups; and
the second set of DMRS antenna ports correspond to a second DMRS CDM group of the two DMRS CDM groups.

19. The apparatus of claim 16, wherein each data layer of the PDSCH is configured to be transmitted using a pair of DMRS ports of the plurality of DMRS antenna ports with different TCI states.

20. The apparatus of claim 19, wherein a first DMRS port of the first set of DMRS antenna ports is paired with a corresponding second DMRS port of the second set of DMRS antenna ports for transmission of a corresponding data layer of the PDSCH.
